(19) United States
(12) Patent Application Publication
(10) Pub. No.: US 2007/0150292 A1
(43) Pub. Date: Jun. 28, 2007

(54) Real estate investment report gererator

(76) Inventor: James Philip Nichols, College Park, MD (US)

Correspondence Address: JAMES P NICHOLS, 10106 51st Ave, College Park, MD, 20740, US

(21) Appl. No.: 11/145,364

(22) Filed: Jun. 6, 2005

(51) Int. Cl. G06Q 99/00; G06Q 30/00

(52) U.S. Cl. 705/1; 705/26

(57) ABSTRACT

A method for generating a report of real estate property information on a set of properties, including pricing and property characteristics, maps, driving directions, driving times, automatically generated lists and map plots of comparable properties (“comps”) sold recently in the area along with their property characteristics, equity analysis, loan amortization and potential cash flow analysis at various possible offer levels and interest rates and at various different rehab cost levels and various possible rent levels, average area rent and other census data, and the resulting hardware/software system for generating and displaying or printing such reports. When potential purchasers have the ability to find value more quickly, possibly within hours of new time-sensitive data being released, they have an advantage in a competitive and fast-moving market.

This invention consists of a method for generating a report of real estate property information on a set of properties, including pricing and property characteristics, maps, driving directions, driving times, automatically generated lists and map plots of comparable properties (“comps”) sold recently in the area along with their property characteristics, equity analysis, loan amortization and potential cash flow analysis at various possible offer levels and interest rates and at various different rehab cost levels and various possible rent levels, average area rent and other census data, and the resulting hardware/software system for generating and displaying or printing such reports.

The intention of the invention is to allow investors, homebuyers, and realtors to generate an efficient report giving them a means to drive around and review a large number of real properties in a very short amount of time, arming them with information and analysis useful to select and make a large number of offers or listings on the spot or in a faster manner than possible by conventional means. When such potential purchasers have the ability to find value more quickly, they have an advantage in a competitive and fast-moving market. It is also useful for review of properties pending an auction.

### OPERATION

The method works on a general-purpose computer as follows:

The user uses a mouse or keyboard to start the program, and then to select a button or menu and/or open a form where the user can activate controls (such as but not limited to buttons, menus, checkboxes, list boxes) to change various settings and turn on various reporting options of the program as described below. The options and settings can also be loaded and saved to disk or other medium as a configuration (config) file for later use. Among the initial settings, the user would need to pick one from a list of target property input data file format types, which can be one of: a file from a national or local information provider such as a foreclosure/preforeclosure or divorce data service or courthouse foreclosure/tax-auction list, or output from a multiple listing service (MLS), or a file with addresses entered by hand to create a target list. After finishing entering other settings as described below, the user selects a button or menu which prompts the user to chooses the actual target property input file, and for each property the program then reads the address, and optionally one or more of the city, state, zip code, price, and possibly other information from the file into a target property data structure in the computer's internal random-access memory (RAM). If the file does not contain certain normally needed fields (such as city, state, or zip code), the user can select an assumed value to be always used for that field. The user can also enter the list of properties directly into the program without using an input file.

If the user wishes the report to also include sales comparables for nearby properties sold in the area near the target properties, the user can then select (usually from the settings form or configuration file) a comparables file format type, which can be a file from a national or local property sales data reporting service, or a file with property sales data from a multiple listing service, a file with property sales data from the county or state, or a file with property sales listings from some other source, which contains at a minimum the address of the property and the price it sold at, and optionally the city, state, zip code, county, subdivision, number of square feet of the property, list price of the property, number of days on the market before selling, year built, number of bedrooms, number of bathrooms, date it sold, owner occupied status, loan type, lot type (waterfront, golf course, etc . . . ), and possibly other user-defined property characteristics. The user then chooses the actual file to read, and the computer reads the area's property sales history into the comparables data structure in internal random-access memory.

The user then can select a button or menu to initiate the display of the properties on a map. This process works by automatically looking up the address of each property in a database of street addresses, such as the United States Census Bureau's TIGER database or any of the commercial databases, most originally based on TIGER, in order to get the latitude and longitude coordinates for each property. Occasionally an ambiguous address will be found, in which case the program displays a list of possible addresses and the user is requested to select which address to use from that list, or to ignore the entry (as is sometimes needed for streets newer than the last U.S. Census). After the property addresses are disambiguated and geographic coordinates are known, they can be sorted by distance to find a fairly efficient driving route using one of a number of standard routing algorithms. One possible greedy distance sort can work by comparing the line of sight or driving distance between each property, and starting from the first property, to pick each next closest unvisited property from the list and go to it next. As a result a list of properties in order will be generated. A better alternative to this greedy-only algorithm is to go backwards for each of the properties in the greedy route, (some of which were often skipped or passed over because they weren't quite close enough and have to be backtracked to), searching through the ordered list for a spot where the total route distance would be shortest if they were inserted there, and insert them there. The route can also be instead ordered by the equity shown in the property, or cash flow amount, or monthly payment amount with a certain interest rate, or net present value amount (value of the future cash flow in today's money), or the proximity of the property to a pending auction, or other criteria other than distance, including combinations of the above. Other standard routing algorithms are possible; the routing algorithm used can be set in the settings form or config file.

Once the properties are sorted, the user can select a button or menu to cause the locations of the properties to be plotted on a map (rendered using map data from the United States Census Bureau's TIGER database or any of the commercial databases or mapping components, most originally based on TIGER) as symbols with their property number, with a route shown between them in a different color in the order decided above.

The user can change the order of the properties to be visited with buttons, menus, or a form, and replot the map to their liking.

If the user would like comparables to be shown on the final report, the user can select a button or menu to prepare the comparables, causing them to be looked up by address to get the latitude and longitude coordinates, in the same manner as done for the target properties above, and with the occasional ambiguous address query to the user. Once the comparables are disambiguated and their geographic location is known, they are automatically compared with each target property using distance and other factors, with each target property data structure receiving a list of closest nearby comparables, possibly only those that meet user-given criteria (such as same number of square feet within a certain threshold, or same number of bedrooms or garages, etc . . . ) as set earlier in the settings form.

The user can then select a button or menu to cause comparables to be plotted on the map, using a separate type of symbol than the target properties so they can be distinguished, possibly with a separate numbering system for identification when the map for each property is plotted later. How comparable symbols are plotted can be set from the options form or config file.

The user can, if desired, then select a button or menu to make the program cause a computer monitor to display a report, or cause an attached computer printer to print out a report, which contains for each target property, the property order number starting with 1, the property address (including possibly city, state, and zip code), the asking price (or default amount/statement of debt for foreclosure candidates), tax assessed value if available, number of square feet if available, calculated price per square foot if dependent data is available, number of units (if multiunit building), number of bedrooms if available, number of bathrooms if available, number of garages if available, year built if available, owner's names if available, plaintiffs if a court case is pending, REO (bank Real Estate Owned) status if available, the date and amount of the last sale for this property if available, the lot size and land value if available, combined with driving directions to get to this next property and a map of the area centered around the given property (with the other properties, the route, and nearby comparables also plotted on the map to show nearby sales activity trends). If the user also chose to load comparables, the report will also show a list or table of the closest nearby properties that have recently sold that meet the user's criteria (for example, within the same range of square footage, or number of bedrooms). Each comparable can optionally be plotted on the map with a different symbol, and possibly a number indicating which comparable it is in the list or table of comparables. Estimated total driving time can also be displayed.

In addition, if the user so selects by form, button or menu item in the settings user interface or config file, a list or table can be printed along with each property containing several possible offer price levels at different percentage discounts, and for each offer level, to show a list or table of monthly payments for several different interest rates, using various types of interest only loans, fixed rate amortized loans, or adjustable amortized loans, or hybrid loans (1 yr fixed then LIBOR ARM, 3 year fixed then LIBOR ARM, etc . . . ), both P&I (principal and interest) payment estimates (which can be calculated by using standard amortization formulas in the prior art), and PITI (principal, interest, taxes, and insurance) estimates, the latter being calculated by adding P&I to both tax data information for the property which is often in the data files available from the state or county or entered by the user (converted to monthly form) and found in the target property data structure, and by adding average insurance estimates for that county or city or by using a user-entered or previously stored insurance calculation equation.

In addition, several different rehab price levels can be optionally added (per the settings form or config file) to the multiple offer price list or table, allowing several kinds of typical rehab or repair estimates (small, large, kitchen-only, etc . . . ) to be added to a given offer price before amortizing the loan payments. The rehab/repair price levels can be based on a few different typical estimate equations for different size jobs, entered by the user or stored in a configuration file for the program, and some of these estimates can be functions of the square footage available in the target property data structures, for improved accuracy. The above described monthly payment calculations can also be done for the “offer price+rehab” loan amounts, and added to the list or table as well.

In addition, for each of the above offer price levels or offer+rehab/repair price levels, several different monthly rental prices can optionally be displayed (if requested through the settings form or config file), calculated by preset formulas, formulas stored in a configuration file, or formulas entered by the user, or based on typical (median, average, etc . . . ) rents of the area from the U.S. Census demographics database or other demographic sources, and the cash flow for each can be calculated, by subtracting a given rent level from a given loan payment level for that part of the list or table. In this way the cash flow estimate can be reported to be negative or positive and by how much for each given offer price and needed repair level by glancing at the report. If requested in the settings form or config file, time value of money formulas (in the prior art) can also be used to calculate and report in the list or table what the net present value (NPV) of a future positive cash flow would be in today's money at a given interest rate, so that the value of different offer levels and other parameters can be better known to the investor at the time of first negotiations, and quickly compared with other possible deals on the list. In addition, a small user-defined percentage for a property management fee will be subtracted from the rent payment before calculating the cash flow, and reported separately in the list or table if so requested in the settings form or config file, in order to determine both cash flow and NPV if a property management company were to be used by the investor for that property.

By having this information in front of him as he views the property, the investor can judge which financial strategy and what kind of offer would work best for that particular property, which properties are the best to make offers on, and be prepared to act on those judgements while he is talking to the owner or otherwise still at the property.

In addition, the report can optionally be split into multiple parts, on separate paper but used together as appropriate, to achieve the same effect. Also, the report and route can optionally be printed off in separate partial reports, such as for example to cover different segments of the city, or other subset, so that more than one investor, homebuyer, or realtor, can each take part of the report and work as a team in reviewing all the properties as quickly as possible.

A user interface entry field can allow the typing in and a button or menu or other control can allow the saving of user notes on the property into a notes file or database, so that comments on the property and neighborhood can be entered in and stored near the rest of the property information for use in a succeeding report generated and shared with others, such as a team of people. The report generator code, which generates the report for each property in sequence, would also contain code to display or print the user notes when displaying or printing other information about the property in the report, when so requested by the settings form or config file.

Also, owner of record, tax, and auction information can be optionally loaded into the program, as selected by the user settings form or config file, to also display the name and address of the current owner in the report, which is useful in determining out-of-state owner or other rental status, as well as identifying government or state or city owned property, and other information such as typical taxes, taxes owed, and the status and dates of any tax or foreclosure auction pending.

Also, this report system can be made available to users over the internet, so that they would be able to use a web browser to activate the same sorts of controls and functions as described above and cause the remote web or other server computer to generate such a report to be displayed on their local computer display, or printed on their local computer printer. User notes and data corrections on individual properties can also be shared with others over the internet by peer-to-peer or file/ftp server uploading or web server uploading via standard prior art file or data transfer protocols as desired by a user by selecting a button or menu or config file setting. In such cases, with the user notes download or data download setting selected, user notes, data, or data corrections can be checked for on an internet server or other machine and downloaded if present before or during the generation of the report for each property.

In addition, by optionally using the above described method and system with a portable computer, the report can be displayed on the portable computer display while in a vehicle while driving around following the driving directions and looking at property. In this situation, the entire report need not be printed out, conserving paper. Also, parts of the report need not be displayed until needed, allowing the user to interactively request portions, such as the amortization, rehab, or cash flow lists or tables, by selecting a button

1. A method for generating and system for generating and printing reports of real estate property information on a set of properties, with reports containing for each property:
property address
driving directions between each property
list or table of automatically selected nearby comparable properties that have recently sold and optionally, their details
maps of area surrounding each property, optionally with locations of comparables plotted optional equity analysis based on average sales price of nearby comparables optional loan payments, possible offer levels, possible rehab levels, and cash flow analysis,
optional aerial or satellite photos of area
whereby with this improvement over the prior art, investors, homebuyers, and realtors can use this report to more efficiently drive around and review a large number of real properties in a shorter amount of time than by a conventional approach and have needed information and analysis useful to immediately make a large number of offers or listings more safely and quickly in a very competitive real estate market.
